(19) United States
(12) Patent Application Publication
(10) Pub. No.: US 2002/0011930 A1
(43) Pub. Date: Jan. 31, 2002

(54) Security barbed wire

(76) Inventor: Sang J. Choi, Homwood, IL (US)

Correspondence Address: SANG J. CHOI, APT # A, 2425 W. 183RD ST, HOMEWOOD, IL, 60430, US

(21) Appl. No.: 09/842,423

(22) Filed: Apr. 27, 2001

(30) Foreign Application Priority Data
May 19, 1994 (GB) 2,272,799
Nov. 19, 1976 (JP) 35,058,199

(51) Int. Cl. G08B 21/00

(52) U.S. Cl. 340/540; 340/541; 340/564

(57) ABSTRACT

This invention is relating to a barbed wire, of which one strand is a conventional iron wire, and the other strand is an electrical wire that includes a conductor covered by a sturdy plastic insulator. The purpose of using an electrical wire is that it can be used for an alarm system where high security is demanded.

### FEDERALLY SPONSORED RESEARCH OR DEVELOPMENT

Not applicable.

### MICROFICHE APPENDIX

Not appendix.

### BACKGROUND OF THE INVENTION

With the installation of a barbed wire of prior art, in the most cases, the objectives can be achieved by deterring any intrusion. However, where high security is demanded, in addition to the normal barbed wire installation, an alarm system can be installed, which can be triggered whenever an intruder cuts the barbed wire. In another prior invention, an insulated conductor wire is inserted in a groove inside the regular iron wire.

With the prior art, the manufacturing process is much more complicated and applying the conductor to an alarm system is very difficult because peeling off the outer iron layer is not easy.

### SUMMARY OF THE INVENTION

This invention pertains to a barbed wire system, which include an electrical wire to be used in an alarm system. Whenever an intruder cuts the barbed wire, it will cut the electrical wire too. This action will trigger the alarm system. This invention provides an improved security system than the conventional barbed wire only installation.

This invention also provides easier manufacturing process for said barbed wire and simpler application of the barbed wire to an alarm system.

### DESCRIPTION OF THE DRAWINGS

FIG. 1 is a pictorial view of a segment of the barbed wire of this invention. It shows that all the components of said barbed wire.

FIG. 2 is a sectional view of an electric wire, which is a distinctive element used as part of said barbed wire.

FIG. 3 is a diagram showing how the barbed wire is used in conjunction with an alarm system.

### DETAILED DESCRIPTION OF THE INVENTION

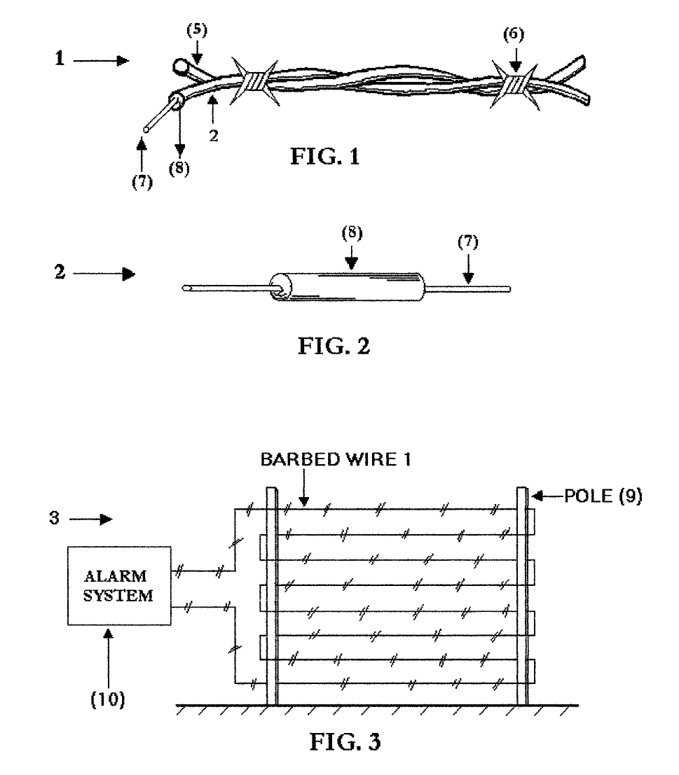

As shown is FIG. 1, a barbed wire 1 comprises a conventional iron wire (5), an electrical wire 2, and many barbs (6). The electrical wire 2 comprises a conductor wire (7) and a plastic insulating shields (8). The barbed wire 1 looks as an ordinary conventional barbed wire in external view, and the electrical wire 2 looks as an ordinary conventional house electrical wire. The thickness of the conductor (7) does not have to be very thick, because the conductor carries very litter current, however, it should be thick and strong enough not to break during the manufacturing and installation process.

The material of the plastic shield (8) should be strong and sturdy enough to be sustained as a barbed wire and flexible enough to be twisted as a barbed wire. The color of the plastic cover should conspicuously be the same as that of the other strand of iron wire (4).

What is claimed is:

1. A barbed wire comprising:
an iron wire;
an electrical wire; and
many barbs.

2. Said barbed wire defined in claim 1 wherein said electrical wire comprise:
a thin conductor wire for carrying a current for an alarm system;
and a thick and sturdy plastic insulating shield for rendering physical strength and insulation means for the conductor being used as a part of barbed wire.

3. A method of utilizing the barbed wire to an alarm system by providing the closed circuit path through the entire barbed wire installed, and whenever an intruder cuts the barbed wire, it will trigger the alarm system.
